(19) United States
(12) Patent Application Publication
(10) Pub. No.: US 2004/0035445 A1
(43) Pub. Date: Feb. 26, 2004

(54) Automated tube cleaner

(76) Inventors: Edward G. Saxon, Oakmont, PA (US); Ben H. Tylenda, Venetia, PA (US); Todd W. Wampler, Elizabeth, PA (US); Eric D. Fullerton, Freeport, PA (US)

Correspondence Address: Armstrong, Westerman & Hattori, LLP, Law and Finance Building, Suite 707, 429 Fourth Avenue, Pittsburgh, PA, 15219, US

(21) Appl. No.: 10/227,364

(22) Filed: Aug. 23, 2002

(51) Int. Cl. B08B 9/04

(52) U.S. Cl. 134/8

(57) ABSTRACT

A semi-automatic cleaning system for removing debris from internal walls of a heat exchanger, or the like, having a plurality of tubes arranged in parallel with each other and ends of the tubes periodically spaced along a spacing line in a plane perpendicular to the tubes. A tool of the system is mounded along the spacing line and a fluid delivery device for providing a high-pressure fluid through each tube is moved from tube opening to tube opening in an automated manner following an initial setup procedure to determine a spacing distance. The spacing distance is revised with movement to each tube opening, so as to correct for any deviation from the nominal tube spacing. The system can include a cleaning device which is inserted into each tube, prior to providing the high-pressure fluid, to scrape and remove deposits, debris, and the like from the internal walls. A pressure sensing device and associated control mechanism are used to determine an exit of the cleaning device so as to enable movement to a next tube for cleaning, and to minimize the time required for cleaning the plurality of tubes.

### FIELD OF THE INVENTION

The present invention relates to apparatus for use in cleaning deposits and debris from internal walls of tubes having a periodic arrangement in a heat exchange vessel.

### BACKGROUND OF THE INVENTION

In many industries, heat exchangers are conveniently used for transferring heat from one medium to another. For example, one form of a heat exchanger is a condenser used in power plants for removing heat from the operating medium at one stage of the power producing operation. Typically, in a power plant operation, water from a natural source, such as a river or a lake, is pumped through heat exchange tubes for cooling the operating medium which is disposed externally to the heat exchange tubes. The condenser typically has a plurality of tubes arranged in parallel relationship to each other, extending from a tube sheet at one end of the tubes to another tube sheet at the other end of tubes. The tubes are typically arranged in a periodic pattern on each tube sheet and the ends of the tubes are welded or otherwise attached to the tube sheets.

During use of a condenser, the internal walls of the tubes become coated with debris, which can include mineral deposits, marine related material and the like. As is well known, any coating on a tube, provided for transferring heat, reduces the transfer of heat and thereby reduces the efficiency of the operation. In order to maintain equipment of this type in efficient operating condition, periodic cleaning is carried out on internal walls of the heat exchange tubes.

One highly efficient method for cleaning the internal walls of the tubes is to pass a resilient scraping tool, which is inserted in one open end of the tube, through the tube for exit at the other end of the tube. Typically a pressurized fluid is charged to one open end of the tube to propel the scraping tool through the tube. During passage through the tube the scraping tool scrapes debris from the internal wall of the tube and discharges the debris out at the other end of the tube. The procedure typically requires at least one operator positioned at one of the tube to insert a scraping tool a short distance into the tube, followed by insertion of a nozzle into that tube opening for delivery of a high pressure fluid for propelling the scraping tool through the tube. The nozzle must be centered on the tube opening and sealed against the opening prior to providing the pressurized fluid, so as to prevent flow of the fluid back towards the operator. Condensers, as described, can contain hundreds of such tubes and the cleaning operation is repetitious and time consuming. Access to the tube ends is often restricted and working conditions can be hot, dirty, and uncomfortable.

U.S. Pat. No. 3,451,091 describes a gun-like device having a funnel mouth which is manually pressed against the tube sheet of a condenser for directing a fluid against a “plug” which is propelled through each tube.

U.S. Pat. No. 4,716,611 describes apparatus for cleaning tubes having an x-y or radially moveable frame for manually aligning a launcher with the tube so as to propel a previously inserted “pig” through the tube. The apparatus must be manually aligned by the operator with each tube.

It is an object of the present invention to provide a semi-automatic method and apparatus for carrying out a condenser tube cleaning operation which significantly reduces the time required for cleaning the tubes.

It is a further object of the present invention to reduce the cleaning time by reducing the time for centering the nozzle at each tube end, the time for passing the scraping tool through the tube with use of the high pressure fluid for propelling the scraping tool, and a means for determining scraping tool exit so as to enable immediate movement of the nozzle, following the scraping tool exit, from the tube being cleaned to the next tube to be cleaned.

### SUMMARY OF THE INVENTION

The present invention is a semi-automatic cleaning system for internal walls of a plurality of tubes having central longitudinal axes arranged parallel to each other, and proximal openings of the tubes located with a periodic spacing distance along a linear spacing line in a plane perpendicular to the axes. The cleaning system has a controller, a fluid delivery means for delivering a high-pressure fluid through the proximal opening of each tube for exit at a distal opening of each tube, a transport means for moving the fluid delivery means successively from one proximal opening location to a presumed next proximal opening location based on a pre-determined and controller-stored spacing distance between two proximal openings, a positioning means to correctly position the fluid delivery means precisely at an actual next proximal opening location when the presumed next proximal opening location does not coincide with the actual next proximal opening location, and spacing distance correcting means for revising the stored spacing distance based on a distance moved to correctly position the fluid delivery means.

### BRIEF DESCRIPTION OF THE DRAWINGS

FIG. 1. is a perspective view of a typical condensing unit for use in describing the tube cleaning system of the invention;

FIG. 2 shows a tool portion of the tube cleaning system of the invention as viewed in the longitudinal direction of the heat exchange tubes when the tool is mounted on the condenser;

FIG. 3 shows the tool portion of the tube cleaning system of the invention as in FIG. 2 from a direction perpendicular to the longitudinal direction of the heat exchange tubes and perpendicular to a spacing line of the condenser when the tool is mounted on the condenser;

FIG. 4 shows the tool portion of the tube cleaning system of the invention as in FIG. 2 from a direction perpendicular to the longitudinal direction of the heat exchange tubes and parallel to the spacing line of the condenser when the tool is mounted on the condenser;

FIG. 5 shows the tool portion of the tube cleaning system of the invention mounted on a condenser with a nozzle in a position spaced from a tube opening;

FIG. 6 shows the tool portion of the tube cleaning system of the invention mounted on the condenser with the nozzle disposed for entering the tube opening in a mis-aligned condition;

FIG. 7 shows the tool portion of the tube cleaning system of the invention mounted on the condenser with the nozzle disposed in proper position for initiating flow of a high-pressure fluid;

FIG. 8 shows a carriage portion of the invention as viewed in the longitudinal direction of the heat exchanger tubes when the tool is mounted on the condenser;

FIG. 9 shows the carriage portion of the invention as viewed in a direction perpendicular to the longitudinal direction of the heat exchange tubes and perpendicular to the spacing line of the condenser when the tool is mounted on the condenser;

FIG. 10 shows a sectional drawing in plane B-B of FIG. 8 of the carriage portion of the invention as viewed in a direction perpendicular to the longitudinal direction of the heat exchange tubes and parallel to the spacing line of the condenser when the tool is mounted on the condenser;

FIG. 11 shows a sectional drawing in plane A-A of FIG. 8 of the carriage portion of the invention as viewed in a direction 180° from the view shown in FIG. 10;

FIG. 12 is a schematic box diagram of the tube cleaning system of the invention;

FIG. 13 is a tube cleaning insert used in combination with the tube cleaning system of the invention;

FIG. 14 is a graphic diagram of fluid pressure versus time as sensed during operation of the cleaning system of the invention; and

FIG. 15 is a schematic box diagram of the tube cleaning system of the invention, in which two tools are provided.

### DETAILED DESCRIPTION OF THE INVENTION

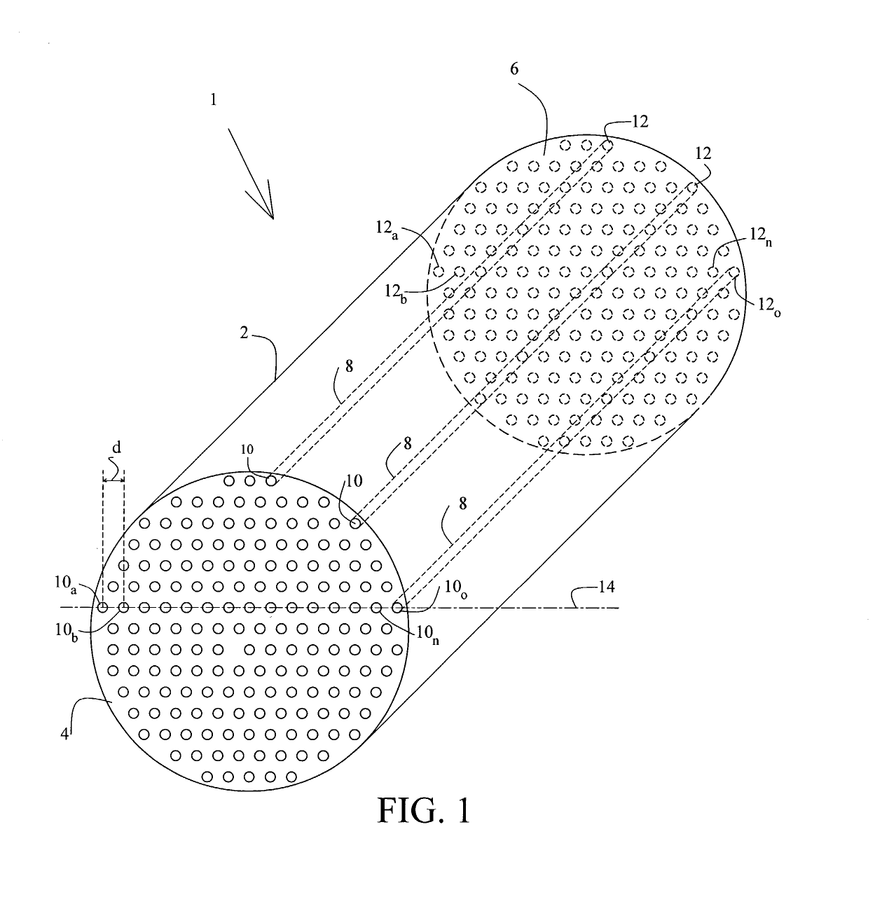

In FIG. 1, a condensing unit is shown in perspective for use in describing the system of the invention. Condenser 1 is made up of condenser walls 2 having tube sheets 4 and 6 at each longitudinal end. A plurality of heat exchange tubes 8, arranged parallel to each other, extend between the two tube sheets. Ends of the tubes, indicated at 10 and 12 are typically welded or otherwise fitted to the tube sheets such that end openings of the tubes are arranged with a periodic spacing. An imaginary spacing line 14, is shown as an example. The tube spacing is typically designed to be the same between tubes along the spacing line, however, in practice the spacing can vary slightly.

The automatic tube cleaning system of the invention is described in reference to the condenser of FIG. 1, however, the system can be utilized for cleaning internal walls of any tubes having a periodic spacing along a spacing line, and ends of the tubes terminating at a plane perpendicular to the longitudinal direction of the tubes.

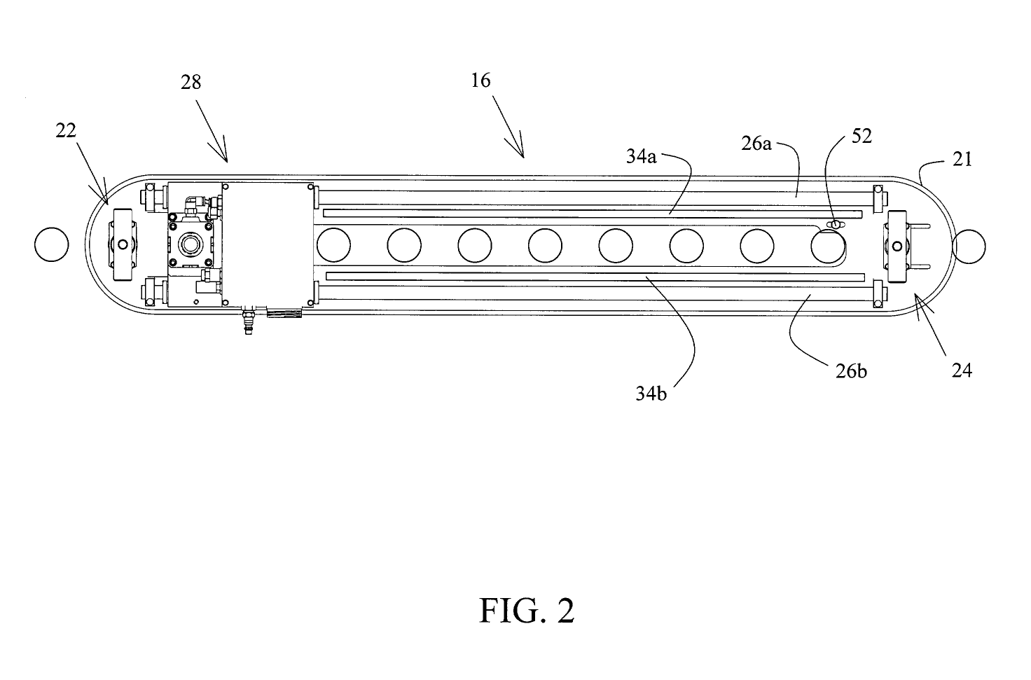

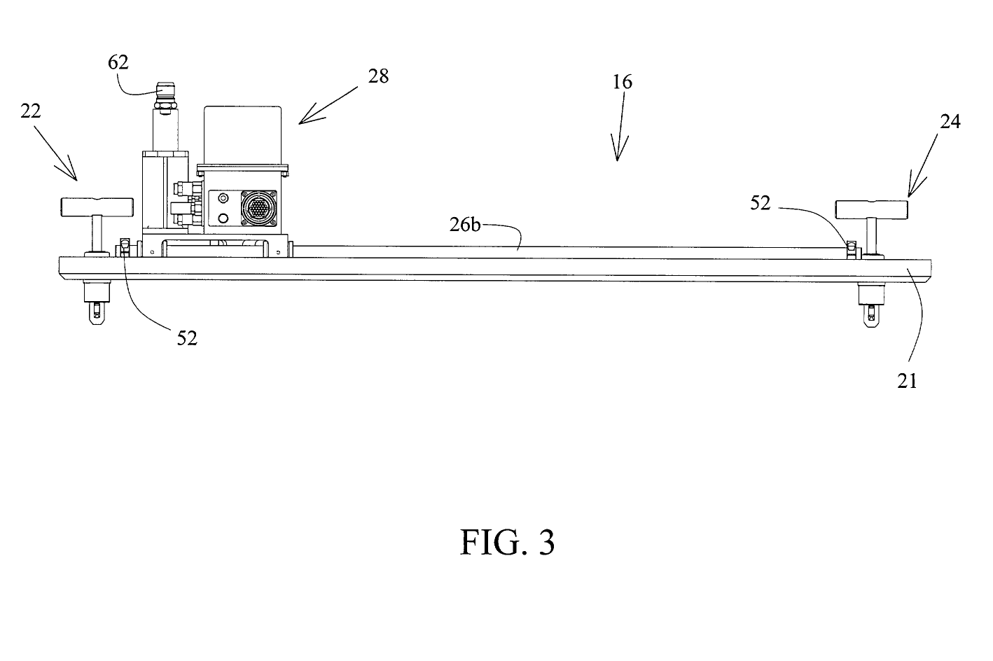

Shown in FIGS. 2-4 is a tool 16 of the system which is mounted to the condenser at one end, so as to have access to one of the openings of each tube, such as tube openings 10a-10o of tubes 8 along spacing line 14, which are indicated as examples. In FIG. 1, only a few of the tubes are shown, so as to more clearly show the tube arrangement. In the description of the cleaning system, tube openings 10ₓ at the end at which tool 16 is mounted are referred to as proximal openings and openings 12ₓ, at the other end of each tube, are referred to as distal openings. Typically, tubes of a condenser have a length of about 30 to 60 feet, and an inside diameter of ¾-¼ inches.

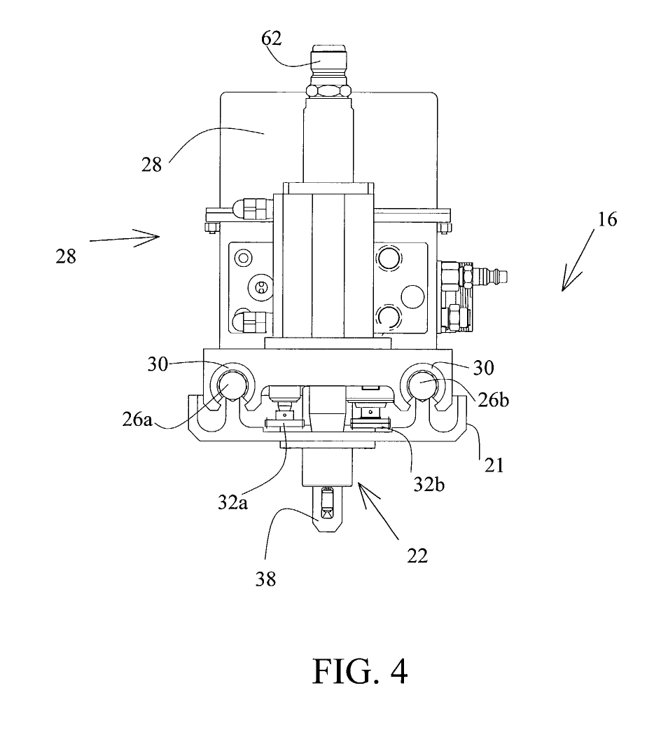

Tool 16 (FIGS. 2-4) includes elongated frame 21 onto which other components of the tool are attached. The other components include fixed gripper assembly 22, adjustable gripper assembly 24, parallel rails 26a and 26b, and carriage assembly 28 which is slidably attached to parallel rails 26a and 26b. Linear bearings such as 30, best viewed in FIG. 4, provide for slideability of the carriage on the rails. The carriage 28 is moveable in longitudinal directions along the rails 26a and 26b by engagement of pinion gear 32b with linear racks 34b. The carriage 28 can be in one of three modes in relationship to the rails and the linear racks. The modes are 1) driving mode, wherein the carriage 28 is being driven in one of the longitudinal directions by pinion gear 32b, 2) neutral mode, wherein the carriage is freely moveable by a force other than pinion gear, along the rails, and 3) brake mode wherein the carriage is locked at a location along the rails. The operation of the system, with use of the various modes is described below.

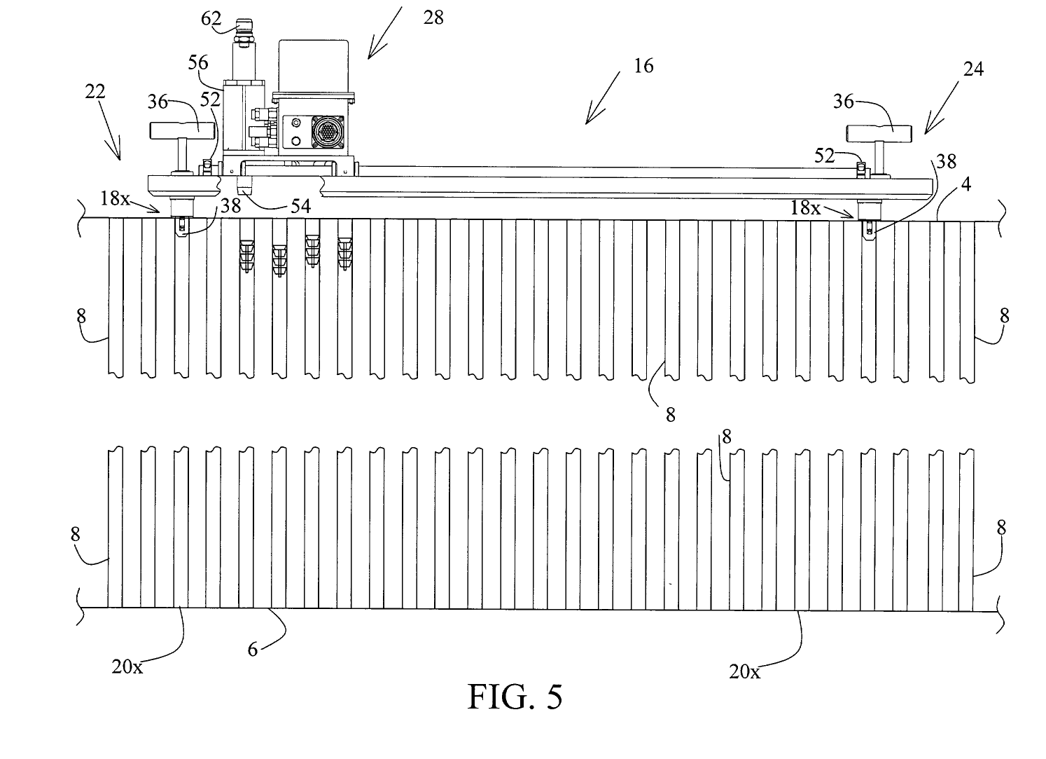

Referring to FIG. 5, tool 16 is mounted on a condenser, such as condenser 1, at an end of the condenser from which the tube cleaning operation is to take place, for example, tube sheet 4 end, as shown in FIG. 1. Mounting is carried out by inserting fixed gripper assembly 22 into one of the tube openings along a spacing line 14, adjusting adjustable gripper assembly 24 to a position whereat it can be inserted into another tube opening along spacing line 14, and inserting gripper assembly 24 into that tube opening. Following insertion of the gripper assemblies into the tube openings, gripper handles 36 are turned to cause the diameter of expandable inserts 38 to increase in diameter thereby locking tool 16 to the condenser. Following expanding the inserts, the adjustable gripper assembly is secured to the frame. The expandable inserts 38 of the gripper assembly are changeable to accommodate various internal diameters found in tubes of different condensers. Usually, once the adjustable gripper assembly is set to a certain spacing, the tool 16 can be moved to other rows of tubes without readjusting the location of the adjustable gripper assembly 24. FIGS. 5-7 are views of the mounted tool having a cross-section taken along spacing line 14 of the condenser in a plane parallel to the longitudinal direction of the condenser tubes. Numerical indicators 4 and 6 indicate the tube sheets 4 and 6 respectively, as shown in FIG. 1.

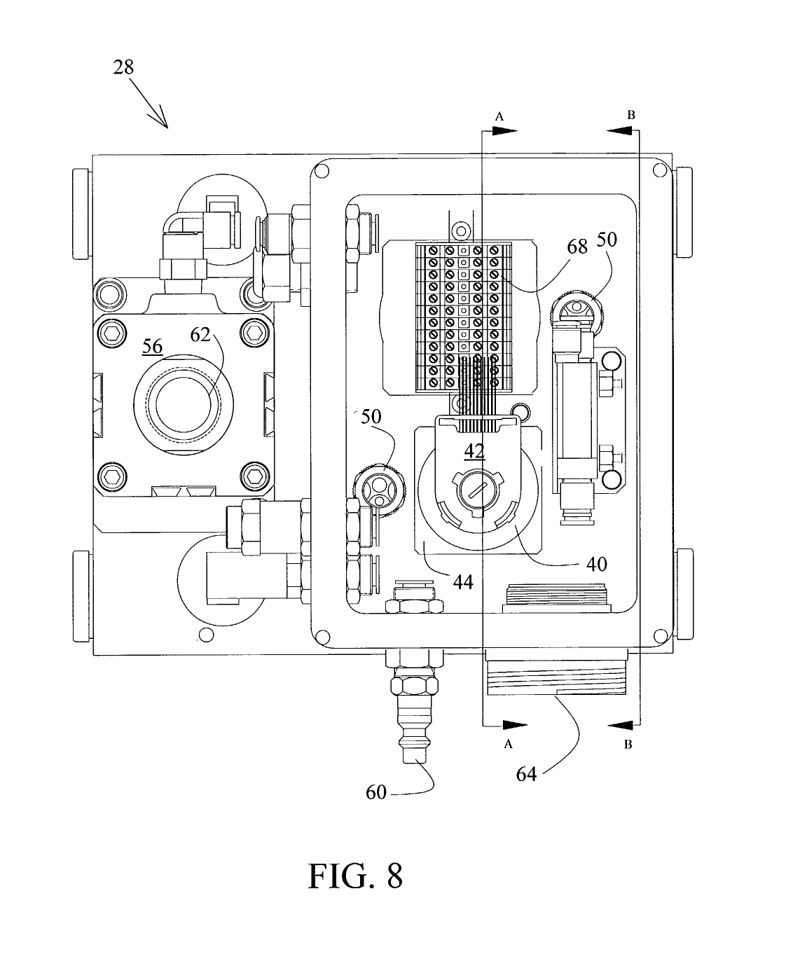

Carriage assembly 28 accommodates components of the system which include those for positioning the carriage assembly for operation, inserting a nozzle of the system into a tube for ejecting a pressurized fluid, and directing flow of the pressurized fluid into a tube. Components of the carriage assembly are described with reference to FIGS. 8-11.

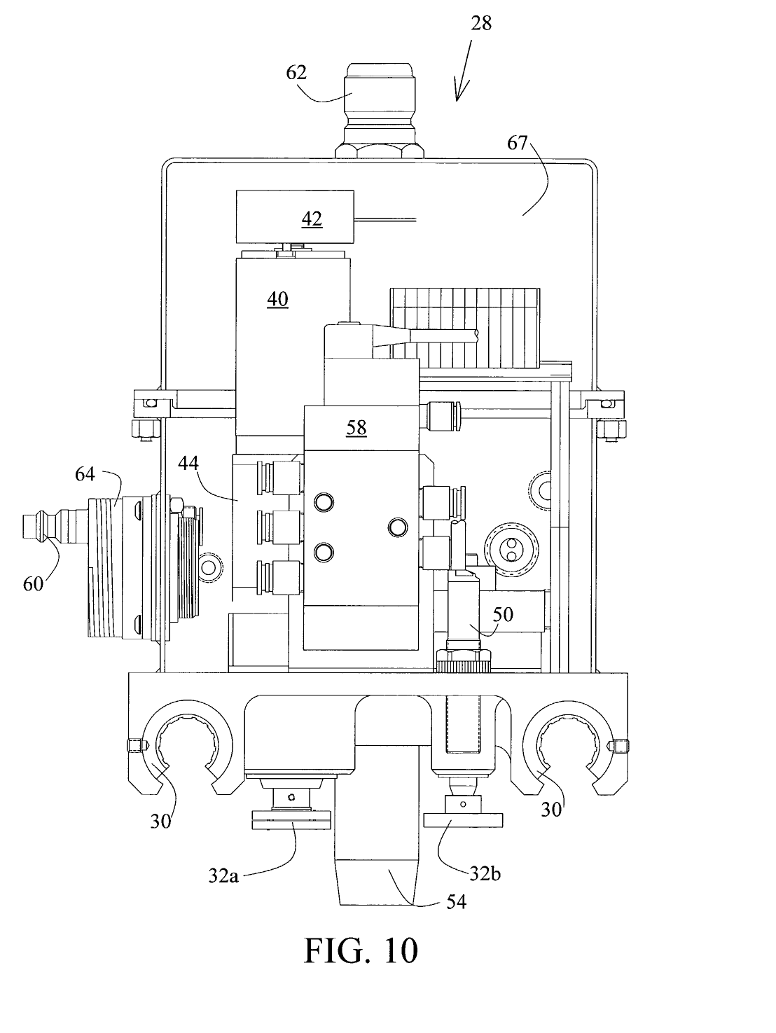

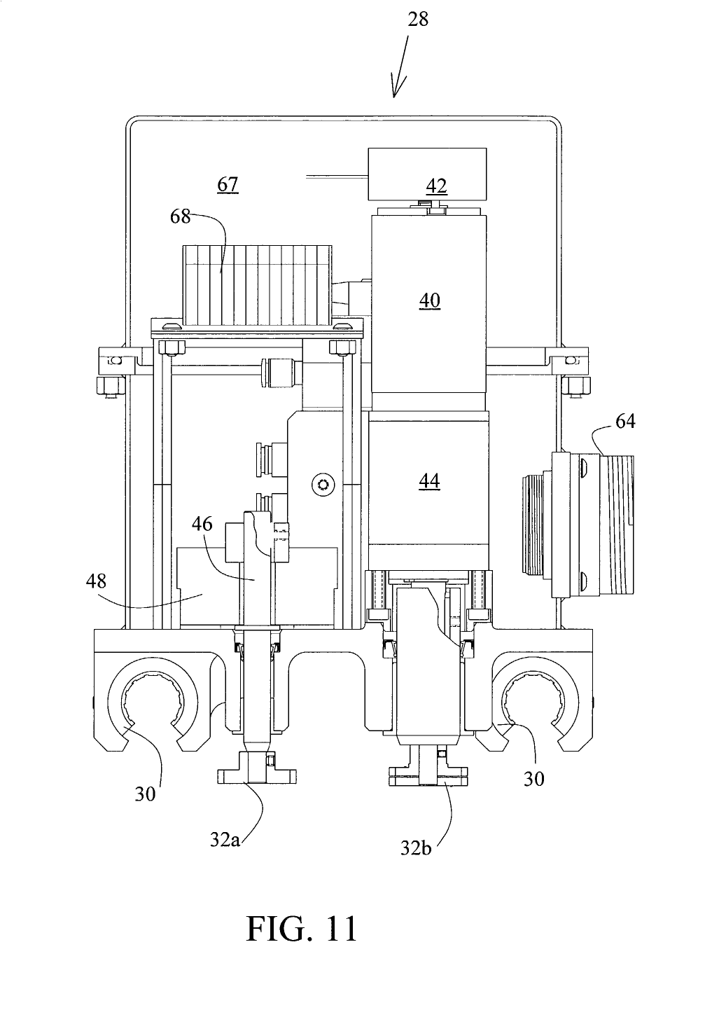

Low voltage electric motor 40 is provided as part of the carriage assembly for driving pinion gear 32b which moves the carriage assembly along parallel rails 26a and 26b by engagement of the driving pinion gear with linear rack 34b. Motor 40 (FIG. 10) is preferably a reversible brushed D.C. motor and for safety concerns for the operator of the system, who typically is in a damp confined environment of the condensing unit, is a low voltage motor (12-24 VDC). Motor 40 is fitted with a digital encoder 42 for use in tracking positions along the spacing line 14 (FIG. 1) described above. The motor preferably provides rotation to pinion gear 32b through planetary gear head 44 (FIG. 11). Pinion gear 32a which engages rack 34a is not driven by the motor. A brake shaft 46, which along with brake mechanism 48 and pinion gear 32a, are used to lock the carrier assembly 28 at a working location along spacing line 14 during operation. The carriage assembly is limited to a specific length of operation on the rails with use of a proximity sensors 50 (FIG. 8) which works in association with proximity sensor flags 52 which are adjustably located on frame 21 (FIGS. 2 & 3).

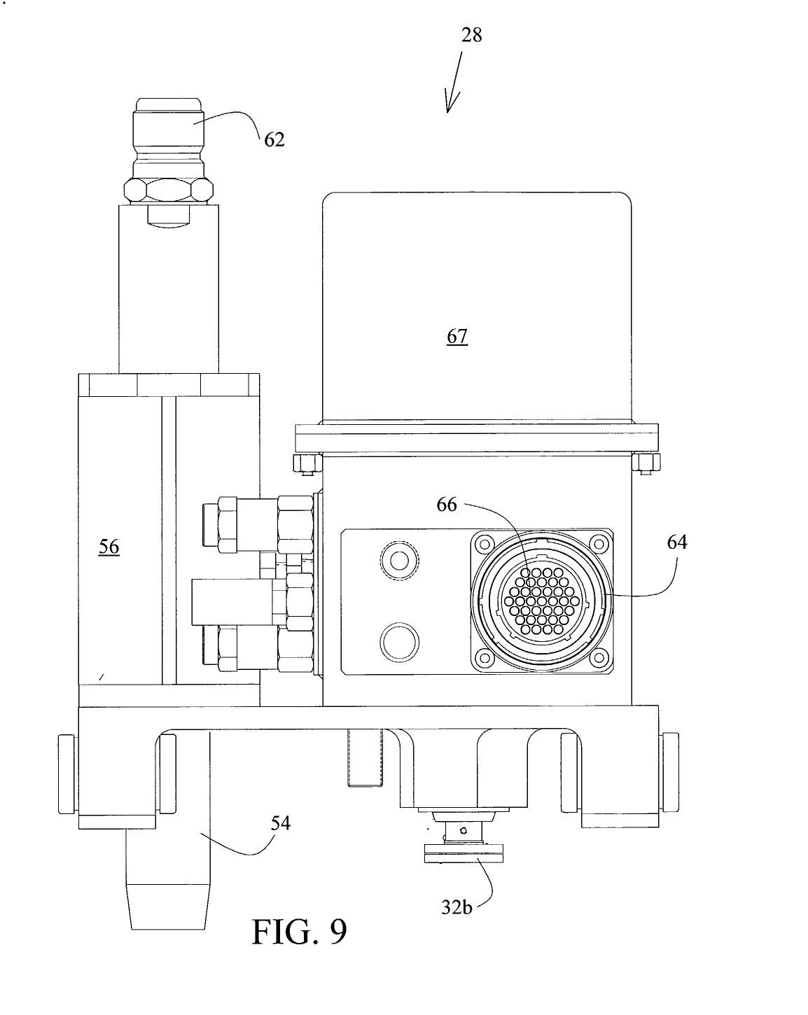

The carriage assembly also includes a tapered nozzle for insertion into tube openings of the condenser for delivering the high pressure fluid into the tube, and a mechanism for moving the nozzle in directions parallel to the longitudinal direction of the tubes, so as to insert the tapered nozzle into a tube opening and retract the tapered nozzle from the tube opening. Nozzle 54 is best viewed in FIGS. 9-11. The insertion and retraction movement of the nozzle is carried out pneumatically with use of pneumatic cylinder assembly 56 (FIG. 9) which is a double acting, double ended cylinder with a large diameter hollow piston which moves along the central axis of the cylinder. Nozzle 54 is attached to one end of the hollow piston and communicates with the hollow portion of the piston. A high-flow quick disconnect fitting 62 is attached to the other end of the hollow piston and also communicates with the hollow portion of the piston. Low voltage solenoid air control valve 58 controls air into each end of the cylinder for movement of the piston and the nozzle. The valve is preferably a 5 way, 2 position type control valve. Compressed air is supplied to valve 58 through quick disconnect fitting 60. High-pressure fluid, which is directed through the nozzle and into the tube openings, is provided through the high-flow quick disconnect fitting 62. Flow of the high-pressure fluid is substantially in a straight line from quick disconnect fitting 62 to nozzle 54 through the hollow portion of the piston.

Electrical power (low voltage) and control cables are provided to the carriage assembly through quick disconnect connection 64 having a plurality of contact pins 66 for providing the low voltage power and control signals. Connector 64 is preferably waterproof as well as enclosure 67, which houses electrical power and control signal terminal block 68. Control signals, which are provided through the control cables, control the operation of motor 40, brake mechanism 48, solenoid 58 and carry control signals to a remote controller (discussed below) from digital encoder 42 and proximity sensors 50.

The above-described tool 16, which is mounted to the proximal ends of two condenser tubes, is typically located, during operation, within a condenser water box of the condensing unit, which is provided with an access port through which at least one operator can enter. Due to the limited and often difficult access, and need to lift tool 16 for mounting, the tool is made of lightweight materials and only essential components of the cleaning system are provided on the tool itself, with other components of the cleaning system being located remote from the tool.

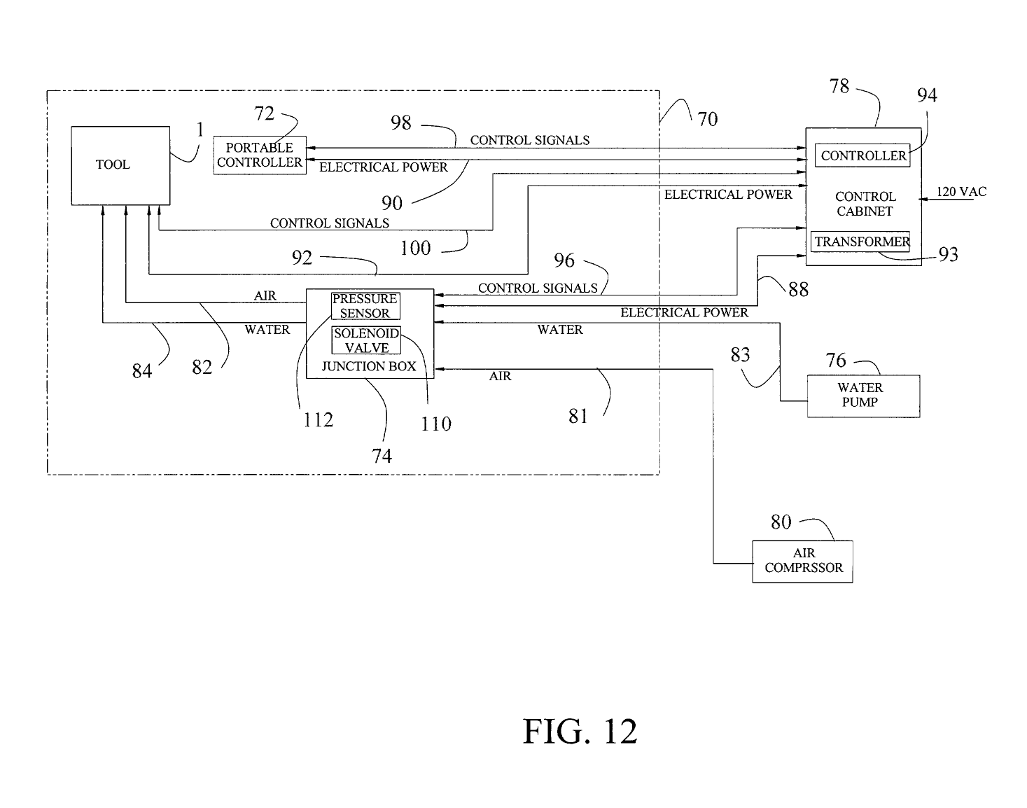

A preferred configuration of the cleaning system is depicted in FIG. 12. In FIG. 12 the condenser water box is indicated by interrupted line 70. Tool 1 is located within the water box as well as a portable controller 72 and a junction box 74. Outside of the water box is a high-pressure water pump 76, a control cabinet 78, and an air compressor 80. Although junction box 74 is shown to be inside the water box 70, in situations wherein the water box area is small, junction box 74 can readily be located outside of the water box.

Compressed air, supplied by air compressor 80, which is used for operation of the pneumatic cylinder 56 is routed through hose 81 to junction box 74 and then through hose 82 to tool 1. A pressure regulator (not shown) is provided at some point in the compressed air line. All of the connections and hoses for the compressed air are of the quick disconnect type, as are connectors for the high pressure fluid, electrical power, and electrical control cables, so as to facilitate setup and teardown of the cleaning system when used at various locations.

High-pressure water (or other suitable fluid) is provided with use of a high-pressure water pump 76 which preferably inputs city water and outputs high-pressure water at a pressure preferably between 250-330 psi. The high-pressure water is routed through hose 83 to the junction box 74, then through hose 84 to tool 1. A valve for controlling the flow of the high pressure water, which because of the pressure must be of substantial size, is located in the junction box rather than on the tool, so as to reduce the weight and size of the tool.

Power to the cleaning system (preferably 120 VAC) is supplied to control cabinet 78 whereat it is distributed to the junction box 74, through cable 88, portable controller 72 through cable 90, and tool 1 through cable 92, all at low voltage (12-24 volts) for safety concerns. Included in the control cabinet 98 is a transformer 93 and controller 94 which includes a computer processor.

Control cable 96 conducts control signals to and from junction box 74, control cable 98 conducts control signals to and from portable controller 72, and control cable 100 conducts control signals to and from tool 1.

Operation of the cleaning system is carried out as follows. The various components of the system are positioned, connected, and energized prior to beginning the actual cleaning process with the arrangement shown in FIG. 12, and discussed above. A row of tubes of the condenser is selected, and the tool 16 is securely mounted along that row with use of grippers 22 and 24 as described above. Although a horizontal row of tubes is depicted in FIG. 1, along spacing line 14, the row of tubes to be cleaned can be along a vertical line or any straight line of tubes having any orientation. The only restriction being that the line of tube openings have openings which are substantially uniformly spaced along that line.

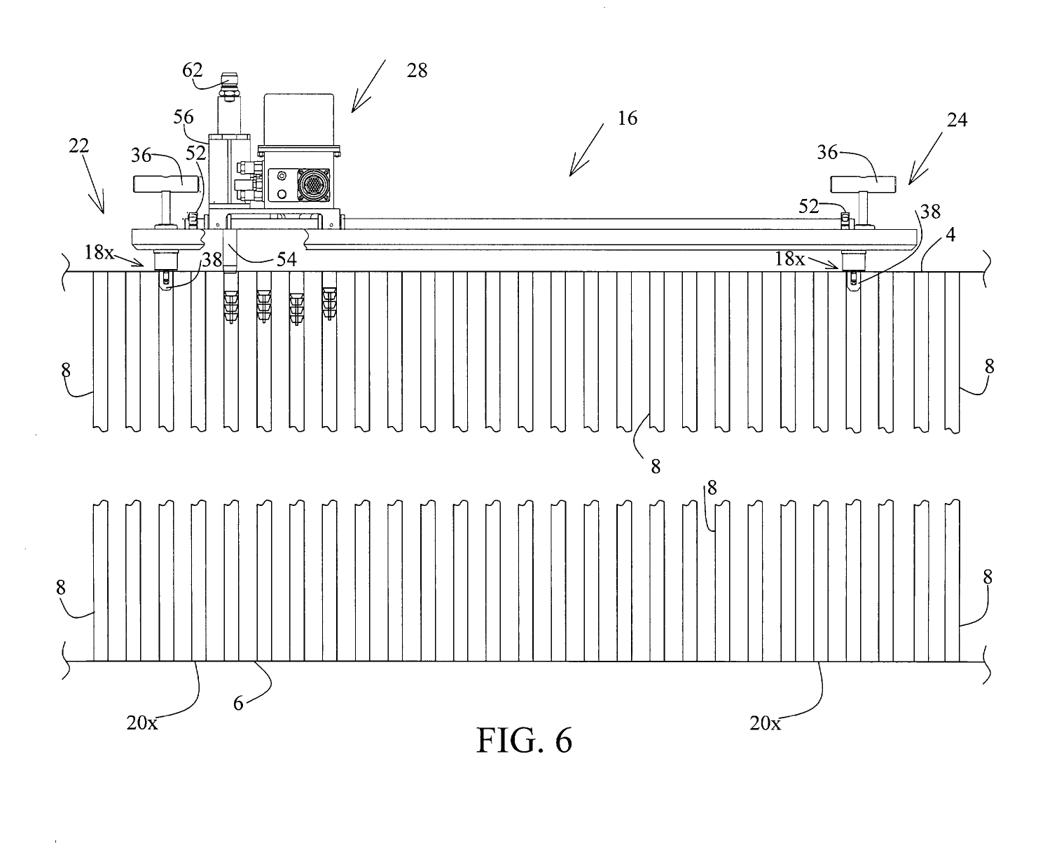

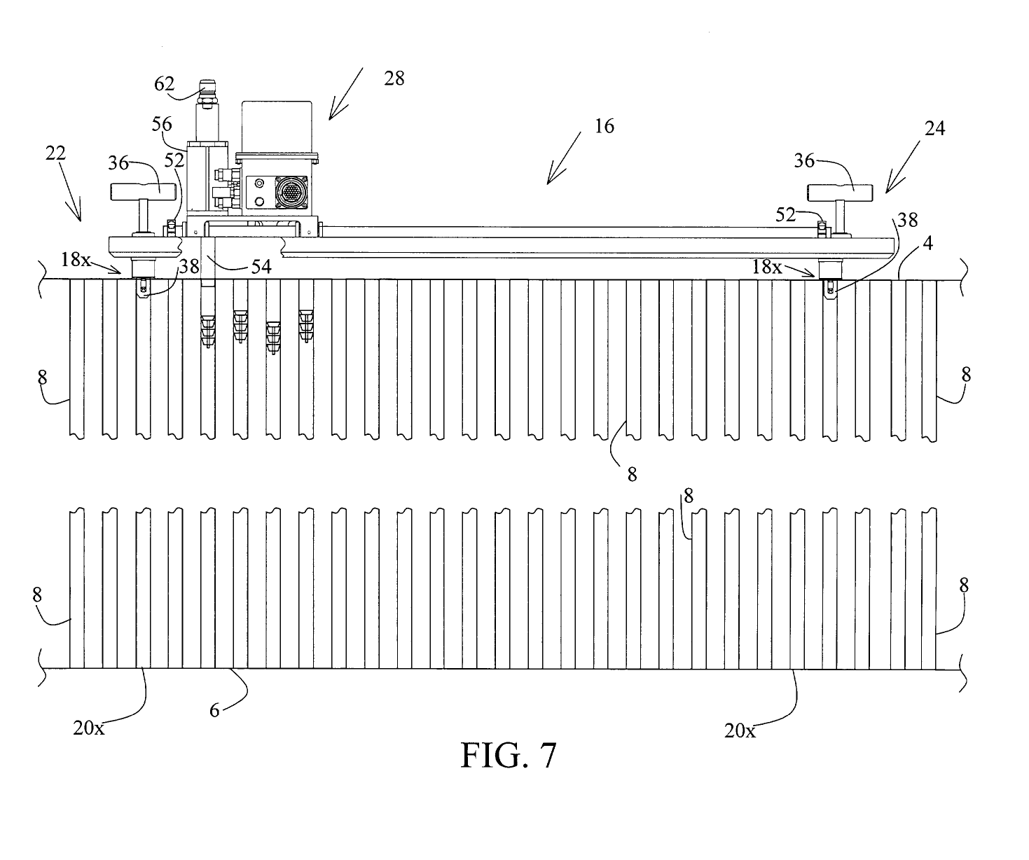

Following mounting of the tool, the tube spacing is inputted to the system controller 94 by the operator, with use of the portable controller 72 which is preferably held by the operator working in close proximity to the tool. With the carriage 28 in neutral mode, the operator roughly aligns nozzle 54 with the first tube 8 to be cleaned (see FIG. 5) and then with use of the portable controller controls the nozzle 54 to enter the tube opening. As the nozzle enters the tube opening (FIG. 6), due to its tapered shape, the nozzle is precisely centered on the tube opening by lateral force on the carriage (in neutral mode) caused by the tapered nozzle 54 contacting portions of the tube opening (FIG. 7). Following that centering operation, the operator, with use of the portable controller 72, instructs the system controller 94 to note the nozzle location along the spacing line with use of data sensed by digital encoder 42.

Next, the nozzle is retracted from the tube opening, with use of the portable controller, and the operator roughly aligns the nozzle with the second tube to be cleaned. The same nozzle inserting and location determining procedure is again carried out as described above. With use of the two tube opening locations determined along the spacing line, a tube spacing distance d1, as shown in FIG. 1, is determined and the spacing distance is stored in the controller which includes a data storage device as well as a device to store operational software of the cleaning system. Following input from the operator to controller 94, the system is instructed to begin tube cleaning, and the carriage (in driving mode) is returned automatically to the first tube opening to begin the automatic cleaning operation. During tube cleaning, the first tube is cleaned (described in detail below) and the carriage is driven to the location of the second tube opening with use of the previously obtained data. Prior to cleaning the third tube, and likewise for each subsequent tube along the spacing line, the carriage is driven to the next presumed location for the next tube to be cleaned and then the nozzle is precisely centered on the tube opening by insertion of the nozzle into the tube opening while the carriage is in neutral mode, and a revised tube spacing distance dx is determined and input to the system controller 94 for use in driving the carriage to the next tube to be cleaned. The system continuously revises the tube spacing distance so as to correct for any non-uniformity in the actual spacing of the tubes. In the operation of the system once the operator has manually positioned the carriage and nozzle in close proximity to the first and second tube, as described above, the system carries out the cleaning operation in a completely automatic manner. The carriage is moved automatically from one tube opening to the next until the operation is terminated either by the operator, or an end of the working range of the tool as sensed by proximity sensor 50.

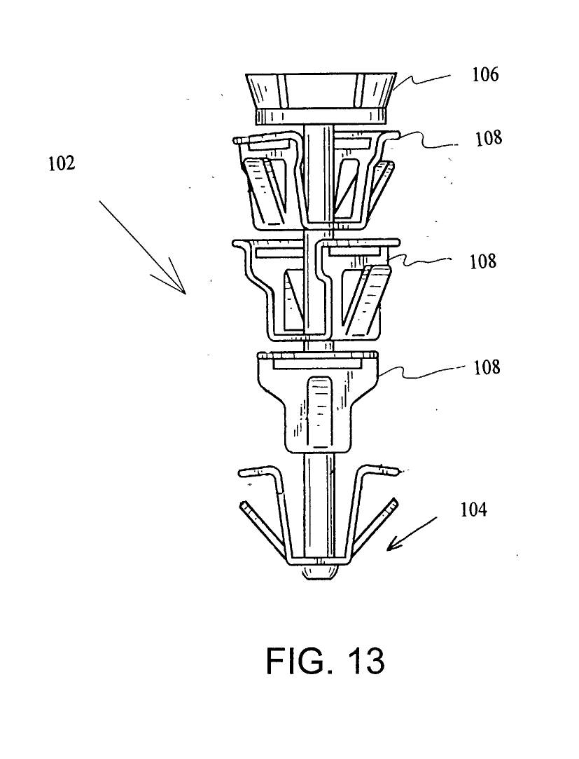

The high-pressure fluid supplied through nozzle 54 in the manner described above is preferably used to force a tube cleaning insert through the tube for exit at distal end 12 of the tube. One tube cleaning insert is depicted in FIG. 13 at 102. Insert 102 has a nose portion 104, a tail portion 106, and scraper devices 108 arranged along the length of the cleaning insert. The tube cleaning inserts are provided to match the inside diameter of the tubes to be cleaned so that the tail portion 106 and scraper devices 108 contact inner walls of the tube with a workable pressure. The tube cleaning insert of FIG. 13 is the subject of U.S. Pat. No. 5,784,745 which is assigned to the present assignee and is hereby incorporated by reference. In operation, prior to insertion of the nozzle 54 into tube opening 18, the tube cleaning insert is manually inserted nose first into the tubes so as to locate tail portion 106 approximately 1-2 inches into the tube as shown in FIGS. 5-7. Following insertion of nozzle 54 into the tube, the insert 102 is propelled through the length of the tube and exits at tube distal opening 12. As the insert moves through the tube, debris, deposits, etc. are scraped from the inner walls of the tube and the scrapped material is flushed from the tube by the high-pressure fluid. The inserts must be manually inserted by the operator into the tubes to be cleaned before the carriage and nozzle approach the tube to be cleaned.

In the sequence of automatic operation of the cleaning system, following movement of the carriage and nozzle to the next tube to be cleaned (driving mode), the nozzle is inserted and centered on the tube opening (neutral mode), and then the carriage is locked in place with use of brake shaft 46 and brake mechanism 48 (brake mode). Next, the high-pressure fluid is provided to the nozzle by the opening of solenoid valve 110, located in junction box 74, which controls the flow of the high pressure fluid from high-pressure pump 76 to nozzle 54.

As mentioned above, a condenser can contain hundreds of tubes, and to clean all of the tubes in the most economical manner, the amount of time spent at each tube must be minimized Therefore, in order to minimize the amount of time at each tube, a detection means is used to detect the exit of the tube cleaning insert 102 from distal end 12, in order that the delivery of high-pressure fluid can be terminated immediately following exit, the nozzle withdrawn from the tube opening, and movement of the carriage to the next tube opening initiated.

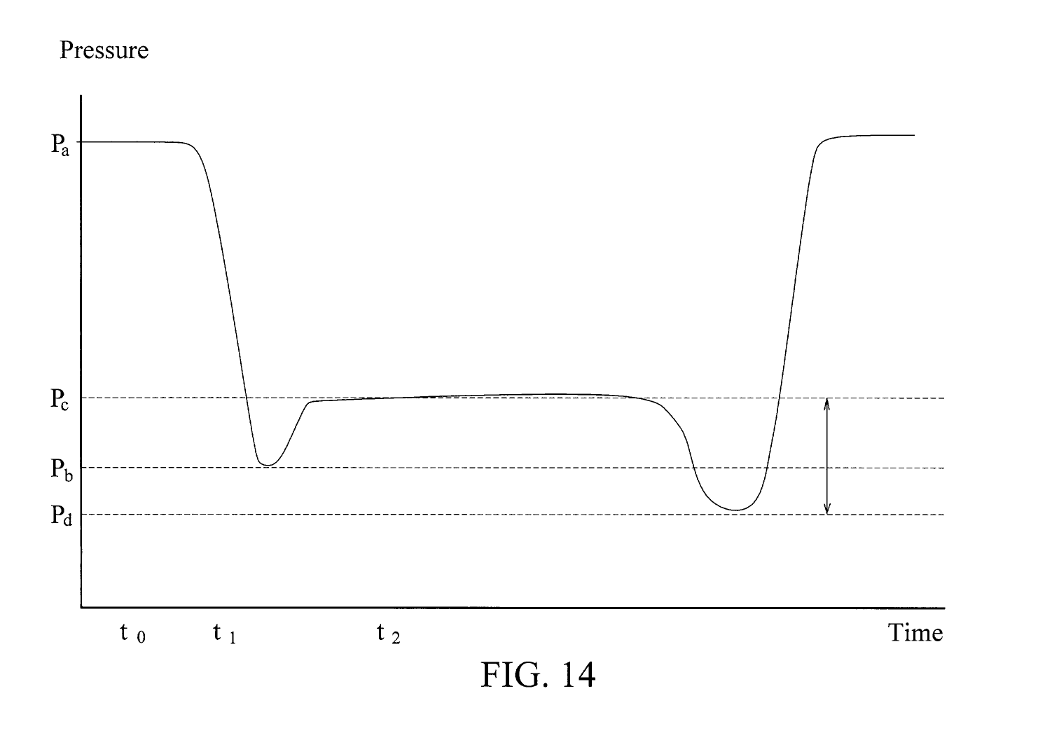

The exit of the tube cleaning insert from distal tube opening 12 is detected by monitoring the pressure of the high-pressure fluid. The pressure is monitored preferably at junction box 74, however a sensor for monitoring the pressure can be located at any point in the high-pressure system between pump 76 and nozzle 54. A pressure sensing device 112 is shown in FIG. 12. FIG. 14 depicts a graph of pressure sensed by sensor 112 (vertical axis) versus time (horizontal axis), beginning at t₀ when nozzle 54 is inserted into a tube opening and solenoid valve 110 is in a closed position. Time t₁, indicates the time of opening solenoid valve 110. Following time t₁ the sensed pressure drops abruptly from a value of Pₐ to a value of P_{b} and then recovers slightly to a substantially steady pressure P_{c} as the high-pressure fluid forces the tube cleaning insert through the length of the tube. Following exit of the insert, and thus less resistance to the flow of the fluid, the pressure drops to a pressure indicated as P_{d}. The system controller 78 monitors the sensed pressure versus time, and determines that the insert has exited the tube when a change in pressure, occurs, for example a 10% drop in pressure from P_{c} to P_{d}. Upon detecting the drop in pressure and thus the exit of the insert, solenoid valve 110 is immediately closed, the pressure rises to Pₐ again, and movement of the carriage and nozzle is immediately begun toward the next tube to be cleaned. In monitoring the pressure versus time, a change (drop) in pressure occurring during a selected period of time, indicated by t₂, is ignored, so as not to obtain an erroneous indication of the tube cleaning insert exiting the tube by detecting the initial drop in pressure to P_{b} when the solenoid valve is opened.

Pressure data obtained with use of the sensor 112 can also be analyzed to call to the operator's attention irregularities in the cleaning operation or the condition of the condenser such as inadvertently not placing an insert into a tube, or a tube which is completely or partially plugged along its length. An audio signal can be used to obtain the operator's attention when an irregularity occurs.

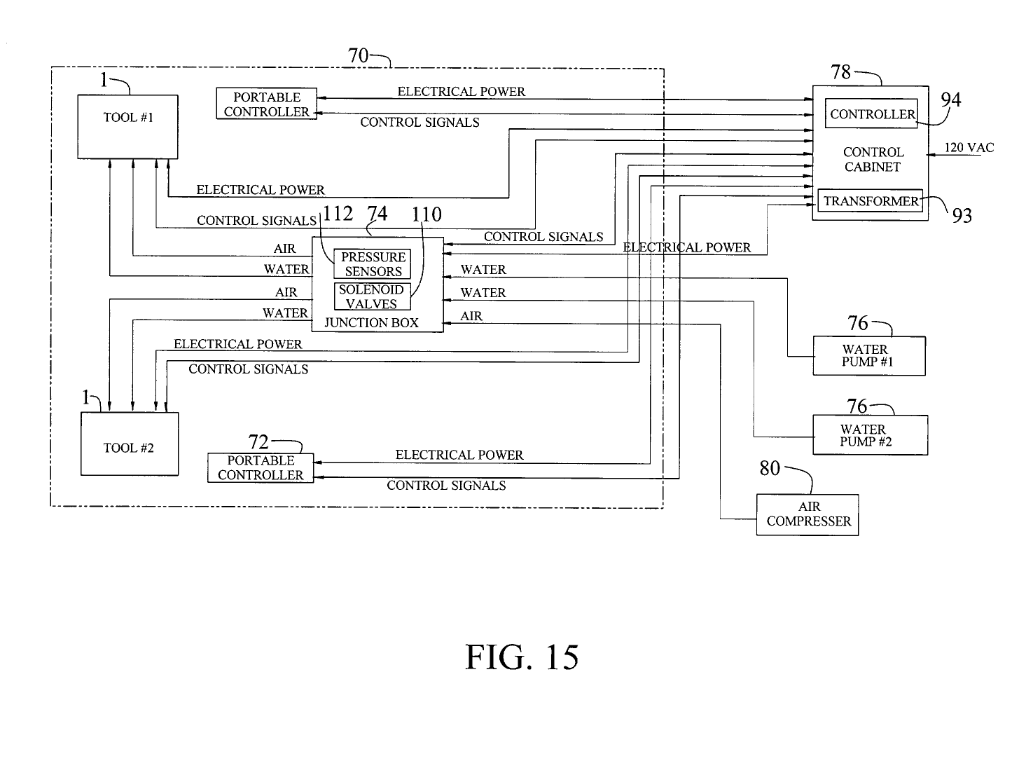

Although the system depicted in FIG. 12 shows a single tool 1, a system configured with 2 tools as shown in FIG. 15, can be used to clean tubes of a condenser in a very efficient manner. The system of FIG. 15 uses single components of the system to support two tools 114 and 116. One operator, positioned in a water box of a condensing unit can mount one tool while the other tool is operating in its automatic mode. In FIG. 15, components of the system are numbered similar to those of the single tool system depicted in FIG. 12.

When such a procedure is used or when only a single tool is used, the initial tube spacing step described above can be by-passed when a row of tubes having substantially the same uniform spacing, as the just-completed row, is subsequently cleaned. When the tool begins automatic operation in the newly selected row, any slight variation in spacing is detected, following insertion of the nozzle into the tube opening, and a revised spacing is determined at each tube opening, so as to operate in the most efficient manner.

Specific apparatus and methods have been set forth for purposes of describing embodiments of the invention. Various modifications can be resorted to, in light of the above teachings, without departing from Applicant's novel contributions; therefore in determining the scope of the present invention reference shall be made to the appended claims.

What is claimed is:

1. A semi-automatic cleaning system for internal walls of a plurality of tubes having central longitudinal axes arranged parallel to each other, and proximal openings of the tubes located with a periodic spacing distance along a linear spacing line in a plane perpendicular to said axes, said cleaning system comprising
a controller,
a fluid delivery means for delivering a high-pressure fluid through said proximal opening of each tube for exit at a distal opening of each tube,
a transport means for moving said fluid delivery means successively from one proximal opening location to a presumed next proximal opening location based on a predetermined and controller-stored spacing distance between two proximal openings.

2. The semi-automatic cleaning system of claim 1, further including
a positioning means to correctly position said fluid delivery means precisely at an actual next proximal opening location when said presumed next proximal opening location does not coincide with said actual next proximal opening location, and
spacing distance correcting means for revising said stored spacing distance based on a distance moved to correctly position said fluid delivery means.

3. The semi-automatic cleaning system of claim 1 or 2, further comprising
an internal wall cleaning device for insertion into each said tube at said proximal end, for movement through said tube and exit at said distal end, by action of said delivered high-pressure fluid.

4. The semi-automatic cleaning system of claim 3, further comprising
fluid delivery controlling means for controlling the duration of delivery of said high-pressure fluid through each tube so as to terminate said high-pressure fluid delivery immediately upon exit of said internal wall cleaning device.

5. The semi-automatic cleaning system of claim 4, wherein
said fluid delivery controlling means bases said duration period on detected changes in fluid pressure within said fluid delivery means during delivery of said high-pressure fluid.

6. The semi-automatic cleaning system of claim 5, wherein
said detected changes in fluid pressure comprises a selected percentage decrease in the fluid pressure during delivery of said high pressure fluid through the tube, occurring after a selected period of time from initiating said delivery, said selected percentage decrease in fluid pressure coinciding with the exit of said wall cleaning device from the tube.

7. The semi-automatic cleaning system of claim 1 or 2, wherein said transport means includes
an elongated frame, and two grippers attached to said frame for insertion into two of said plurality of tubes, through said proximal openings, to secure said frame to said two tubes with a longitudinal axis of the frame in a parallel relationship to said spacing line.

8. The semi-automatic cleaning system of claim 7, wherein said transport means further includes
at least two rails attached to said frame in parallel relationship to the longitudinal axis of the frame, for guiding said fluid delivery means along said spacing line,
at least two linear racks attached to said frame, in parallel relationship to the longitudinal axis of the frame, for use in moving and preventing movement of said fluid delivery means along said spacing line, and
proximity sensor flags attached to said frame for limiting the length of travel of said fluid delivery means along said spacing line.

9. The semi-automatic cleaning system of claim 8, wherein said transport means further includes
a carriage, slidingly attached to said at least two rails,
a motor attached to said carriage, for rotating an associated drive pinion gear having engagement with one of said linear racks for moving said fluid delivery means along said spacing line,
a brake mechanism, for acting on an associated brake pinion gear having engagement with another of said linear racks attached to said carriage, for preventing movement of said fluid delivery means along said spacing line,
a digital encoder in communication with said motor for indexing positions along said spacing line, and
proximity sensors, attached to said carriage, for use in combination with said proximity sensor flags attached to said frame, for limiting the length of travel of said fluid delivery means along said spacing line.

10. The semi-automatic cleaning system of claim 1 or 2, wherein said fluid delivery means includes
a tapered nozzle for delivering said high-pressure fluid, for insertion into the proximal opening of each tube in a direction parallel to the tube's longitudinal axis, and
an insertion device for mounting of said nozzle and moving said nozzle in directions parallel to the tubes' longitudinal axes.

11. The semi-automatic cleaning system of claim 10, wherein said insertion device is a pneumatically controlled piston and associated cylinder, said piston having a hollow central portion in communication with said nozzle, whereby said high-pressure fluid flows through said hollow central portion of the cylinder and said nozzle.

12. The semi-automatic cleaning system of claim 1 or 2, wherein said controller includes
a central processing unit,
a data storage device, and
a storage device for storing operational software of the system.

13. The semi-automatic cleaning system of claim 1 or 2, further comprising
a portable controller for use by an operator in close proximity to said proximal tube openings to control selected operations of said system,
a high-pressure fluid pump for providing said high-pressure fluid to said fluid delivery means,
an air compressor for providing compressed air for operation of said fluid delivery means, and
a solenoid valve for controlling flow of said high-pressure fluid from said high-pressure fluid pump to said fluid delivery means.

14. A method for semi-automatically cleaning internal walls of a plurality of tubes having central longitudinal axes arranged parallel to each other, and proximal openings of the tubes located with a periodic spacing distance along a linear spacing line in a plane perpendicular to said axes, said method comprising
establishing a cleaning cycle including
starting and stopping delivery of a high-pressure fluid through a first tube by a fluid delivery means,
moving said fluid delivery means to proximal openings of successive tubes of said plurality of tubes, with use of a transport means, and
repeating said cleaning cycle.

15. The method of semi-automatically cleaning of claim 14, further comprising
inserting an internal wall cleaning device into each tube to be cleaned prior to delivering said high-pressure fluid, and
moving said cleaning device through the entire length of each tube to exit at a distal end by action of said high pressure fluid.

16. The method of semi-automatically cleaning of claim 14 or 15, further comprising
following said moving of said fluid delivery means to a proximal opening of each successive tube, repositioning said fluid delivery means with use of a positioning means to position said fluid delivery means precisely at said proximal opening, if not located thereat, and
revising said cleaning cycle.

17. The method of semi-automatically cleaning of claim 15, wherein said cleaning cycle includes
determining when said cleaning device exits the distal end of each tube, then
immediately stopping delivery of said high-pressure fluid, and then
immediately moving said fluid delivery means to said next tube.

18. The method of semi-automatically cleaning of claim 15, wherein
said determining of the exit of the cleaning device is based on a pressure profile of pressure within said fluid delivery means during delivery of said high-pressure fluid.

19. The method of semi-automatically cleaning of claim 18, wherein exit of said cleaning device is determined to occur when said pressure profile decreases a selected percentage after a selected period of time following initiating delivery of said high-pressure fluid.

20. A method for semi-automatically cleaning internal walls of a plurality of tubes having central longitudinal axes arranged parallel to each other, and proximal openings of the tubes located with a periodic spacing distance along a linear spacing ling in a plane perpendicular to said axes, said method comprising
providing a controller,
providing a fluid delivery means for delivering a high-pressure fluid through said proximal opening of each tube for exit at a distal opening of each tube,
providing a transport means for moving said fluid delivery means to said plurality of proximal openings located along said spacing line,
providing a positioning means to position said fluid delivery means precisely at a proximal opening location,
mounting said transport means to said tubes with a longitudinal axis of said transport means being parallel to a spacing line of tubes selected to be cleaned,
determining the spacing distance with use of said controller and storing said spacing distance in said controller,
delivering high-pressure fluid to one of said tubes, then moving said fluid delivery means with use of said transport means along said spacing line in the amount of the determined spacing distance to position said fluid delivery means at a presumed proximal opening,
repositioning said fluid delivery means with use of said positioning means to position said fluid delivery means precisely at said proximal opening location if not located thereat,
revising said spacing distance stored in said controller based on said repositioning distance prior to moving said fluid delivery means to the next successive proximal opening location,
storing said revised spacing distance in said controller, and
repeating said high-pressure fluid delivery step and subsequent steps for said plurality of tubes to be cleaned.

21. The method of semi-automatically cleaning of claim 20, further comprising inserting an internal wall cleaning device into each tube to be cleaned prior to delivering said high-pressure fluid, and
moving said cleaning device through the entire length of each tube to exit at a distal end by action of said high pressure fluid.

22. The method of semi-automatically cleaning of claim 21, further comprising
sensing the pressure of the high-pressure fluid in said high-pressure delivery means during delivery of said high-pressure fluid,
determining the exit of said internal wall cleaning device from said tube by analyzing a profile of said sensed pressure with use of said controller,
terminating said high-pressure fluid delivery immediately following determination of said exit, then
immediately moving said fluid delivery means to the next successive tube for continued cleaning of each tube along said spacing line.

23. The method of semi-automatically cleaning of claim 22, wherein
exit of said cleaning device is determined to occur when said profile shows a selected percentage decrease in the fluid pressure, during delivery of said high-pressure fluid through the tube, occurring after a selected period of time from initiating said delivery.

24. The method of semi-automatically cleaning of claim 20, wherein said transport means includes
at least two rails attached to a frame, oriented in parallel relationship to the spacing line, for guiding said fluid delivery means along said spacing line,
at least two linear racks, attached to said frame, oriented in parallel relationship to the spacing line, for use in moving and preventing movement of said fluid delivery means along said spacing line,
a carriage, slidingly attached to said at least two rails,
a motor attached to said carriage, for rotating an associated drive pinion gear having engagement with one of said linear racks and
a brake mechanism, for acting on an associated brake pinion gear having engagement with another of said linear racks attached to said carriage, for preventing movement of said fluid delivery means along said spacing line, wherein said method includes
rotating said drive pinion gear engaged with one of said linear racks, during said step of moving said fluid delivery means,
removing restraints for movement along said rails, during said step of repositioning said fluid delivery means, and
restraining said fluid delivery means from movement along said rails, by activating said brake mechanism acting on said brake pinion gear engaged with another one of said linear racks, during said step of delivering said high-pressure fluid.
